(19) United States
(12) Patent Application Publication
(10) Pub. No.: US 2021/0344772 A1
(43) Pub. Date: Nov. 4, 2021

(54) DISTRIBUTED DATABASE SYSTEMS INCLUDING CALLBACK TECHNIQUES FOR CACHE OF SAME

(71) Applicant: Nutanix, Inc., San Jose, CA (US)

(72) Inventors: Durga Mahesh Arikatla, San Jose, CA (US); Manoj Premanand Naik, San Jose, CA (US); Shyamsunder Prayagchand Rathi, Sunnyvale, CA (US); Vyas Ram Selvam, Seattle, WA (US); Yati Nair, Fremont, CA (US)

(73) Assignee: Nutanix, Inc., San Jose, CA (US)

(21) Appl. No.: 17/244,813

(22) Filed: Apr. 29, 2021

Related U.S. Application Data
(60) Provisional application No. 63/018,201, filed on Apr. 30, 2020.

(51) Int. Cl. H04L 29/08; G06F 16/27; G06F 16/25; G06F 16/23

(52) U.S. Cl. CPC H04L 67/2842; H04L 67/1097; G06F 16/235; G06F 16/256; G06F 16/273

(57) ABSTRACT

Examples of distributed database systems are described. Multiple computing nodes may be utilized to provide a distributed database system. Each of the multiple computing nodes may cache a portion of the distributed database. The cache may be utilized to service write requests. A computing node servicing a write request may provide a callback to other computing nodes hosting the distributed database. The local cache may be updated responsive to the write request and callbacks issued to the other computing nodes to allow for updates of other local caches. In this manner, a local cache may be updated prior to updating the distributed database as a whole in some examples. While callbacks may be used to update cached data on other nodes, the computing node servicing the write request may not need to receive a callback prior to updating the local cache.

### CROSS-REFERENCE TO RELATED APPLICATIONS

This application claims the benefit under 35 U.S.C. § 119 of the earlier filing date of U.S. Provisional application Ser. No. 63/018,201 filed Apr. 30, 2020 the entire contents of which are hereby incorporated by reference in their entirety for any purpose.

### TECHNICAL FIELD

Examples described herein relate generally to virtualized systems and/or distributed database systems. Examples of distributed database cache maintenance using callbacks are described.

### BACKGROUND

Distributed databases may store data across multiple locations. Various types of data may be shared between two or more nodes and may be stored in a database that provides a centralized interface to all the nodes. However, if the data values are read many times in the data path, accessing them from the database can result in a significant delay to the data path clients, such as if the database needs to fetch the data from remote nodes.

If data from the distributed database is cached, maintaining synchronization between the database and local caches can introduce complexity.

### BRIEF DESCRIPTION OF THE DRAWINGS

FIG. 1 is a schematic illustration of a distributed computing system hosting a virtualized file server which may include a database service arranged in accordance with examples described herein.

FIG. 2 is a schematic illustration of a distributed database arranged in accordance with examples described herein.

FIG. 3 is a schematic illustration of a computing node arranged in accordance with examples described herein

### DETAILED DESCRIPTION

Examples of distributed database systems are described. Multiple computing nodes may be utilized to provide a distributed database system. Each of the multiple computing nodes may cache a portion of the distributed database. The cache may be utilized to service write requests. A computing node servicing a write request may provide a callback to other computing nodes hosting the distributed database and/or other caches. The local cache may be updated responsive to the write request and callbacks issued to the other computing nodes to allow for updates of other local caches. In this manner, a local cache may be updated prior to updating the distributed database as a whole in some examples. While callbacks may be used to update cached data on other nodes, the computing node servicing the write request may not need to receive a callback prior to updating the local cache.

Certain details are set forth herein to provide an understanding of described embodiments of technology. However, other examples may be practiced without various of these particular details. In some instances, well-known computing system components, virtualization components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

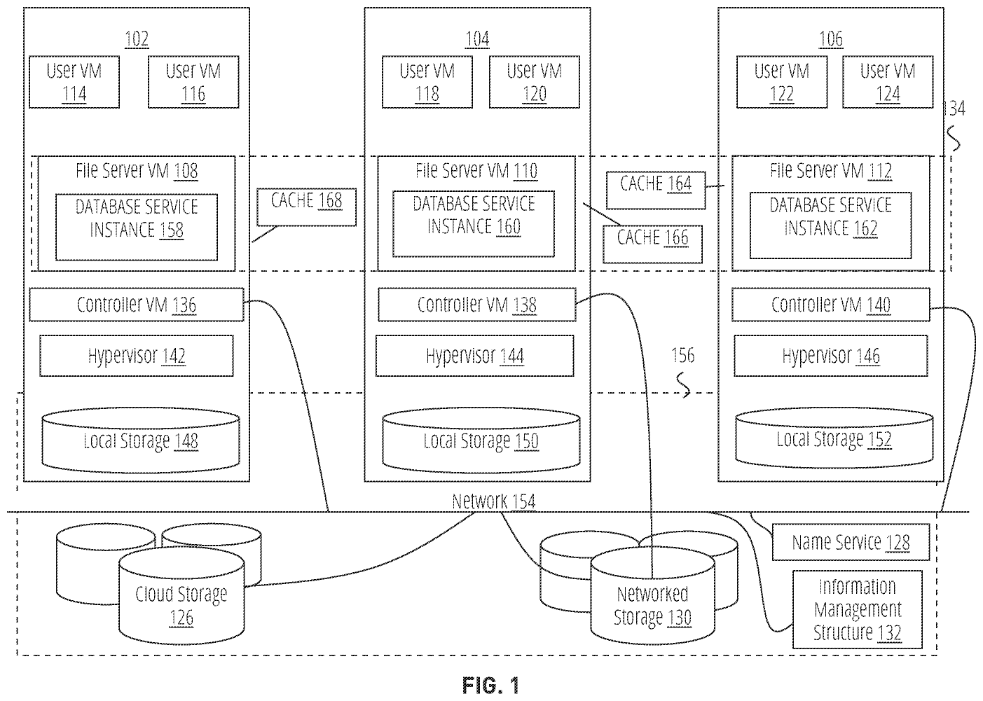

FIG. 1 is a schematic illustration of a distributed computing system 100 hosting a virtualized file server which may include a distributed database service arranged in accordance with examples described herein. The system 100, which may be a virtualized system and/or a clustered virtualized system, includes a virtualized file server (VFS) 134. While shown as a virtual machine, examples of distributed file servers and/or database services described herein may be implemented using one or more virtual machines, containers or both. The database service may provide access to a distributed database. Data stored by the distributed database may be distributed across the various storage devices shown in FIG. 1 in some examples.

The system of FIG. 1 may be implemented using a distributed computing system. Distributed computing systems generally include multiple computing nodes (e.g., physical computing resources)—computing nodes (e.g., host machines) 102, 104, and 106 are shown in FIG. 1—that may manage shared storage. The storage may include storage that is accessible through network 154, such as, by way of example and not limitation, 126 (e.g., which may be accessible through the Internet), network-attached storage 130 (NAS) (e.g., which may be accessible through a LAN), and/or a storage area network (SAN). Examples described herein may also permit local storage 148, 150, and 152 that is incorporated into or directly attached to the host machines to be managed as part of storage pool 156. Examples of such local storage include solid state drives (SSDs), hard disk drives (HDDs, and/or “spindle drives”), optical disk drives, external drives (e.g., a storage device connected to a host machine via a native drive interface or a serial attached SCSI interface), or any other direct-attached storage. These storage devices, both direct-attached and network-accessible, collectively form storage pool 156. Virtual disks (or “vDisks”) may be structured from the physical storage devices in storage pool 156. A vDisk generally refers to a storage abstraction that is exposed by a component (e.g., a virtual machine, hypervisor, and/or container described herein) to be used by a client (e.g., a user VM, such as user VM 114). In examples described herein, controller VMs—e.g., controller VM 136, 138, and/or 140 of FIG. 1 may provide access to vDisks. In other examples, access to vDisks may additionally or instead be provided by one or more hypervisors (e.g., hypervisor 142, 144, and/or 146). In some examples, the vDisk may be exposed via iSCSI (“internet small computer system interface”) or NFS (“network file system”) and may be mounted as a virtual disk on the user VM. In some examples, vDisks may be organized into one or more volume groups (VGs).

Each host machine 102, 104, 106 may run virtualization software. Virtualization software may include one or more virtualization managers (e.g., one or more virtual machine managers, such as one or more hypervisors, and/or one or more container managers). Examples of hypervisors include NUTANIX AHV, VMWARE ESX(I), MICROSOFT HYPER-V, DOCKER hypervisor, and REDHAT KVM. Examples of container managers including Kubernetes. The virtualization software shown in FIG. 1 includes hypervisors 142, 144, and/or 146 which may create, manage, and/or destroy user VMs, as well as manage the interactions between the underlying hardware and user VMs. While hypervisors are shown in FIG. 1, container managers may be used additionally or instead in other examples. User VMs may run one or more applications that may operate as “clients” with respect to other elements within system 100. While shown as virtual machines in FIG. 1, containers may be used to implement client processes in other examples. Hypervisors may connect to one or more networks, such as network 154 of FIG. 1 to communicate with storage pool 156 and/or other computing system(s) or components.

In some examples, controller virtual machines, such as CVMs 136, 138, and 140 of FIG. 1 are used to manage storage and input/output (“I/O”) activities. While examples are described herein using CVMs to manage storage I/O activities, in other examples, container managers and/or hypervisors may additionally or instead be used to perform described CVM functionality. The arrangement of virtualization software should be understood to be flexible. In some examples, CVMs act as the storage controller. Multiple such storage controllers may coordinate within a cluster to form a unified storage controller system (e.g., the controller VMs 136, 138, and 140 may operate together in a cluster to present a distributed storage controller). CVMs may run as virtual machines on the various host machines, and work together to form a distributed system that manages all the storage resources, including local storage, network-attached storage 130, and cloud storage 126. The CVMs may connect to network 154 directly, or via a hypervisor. Since the CVMs run independent of hypervisors 142, 144, and/or 146, in examples where CVMs provide storage controller functionally, the system may be implemented within any virtual machine architecture, since the CVMs of particular embodiments can be used in conjunction with any hypervisor from any virtualization vendor. In other examples, the hypervisor may provide storage controller functionality and/or one or containers may be used to provide storage controller functionality (e.g., to manage I/O request to and from the storage pool 156).

A host machine may be designated as a leader node within a cluster of host machines. For example, host machine 104, may be a leader node. A leader node may have a software component designated to perform operations of the leader. For example, CVM 138 on host machine 104 may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node.

Virtual disks may be made available to one or more user processes. In the example of FIG. 1, each CVM 136, 138, 140 may export one or more block devices or NFS server targets that appear as disks to user VMs 114, 116, 118, 120, 122, and 124. These disks are virtual, since they may be implemented by the software running inside CVMs 136, 138, and/or 140, or other virtualization software. Thus, to user VMs, CVMs appear to be exporting a clustered storage appliance that contains some disks. User data (e.g., including the operating system in some examples) in the user VMs may reside on these virtual disks.

Performance advantages can be gained in some examples by allowing the virtualization system to access and utilize local storage 148, 150, and 152. This is because I/O performance may be much faster when performing access to local storage as compared to performing access to network-attached storage 130 across a network 154. This faster performance for locally attached storage can be increased even further by using certain types of optimized local storage devices, such as SSDs.

As a user process (e.g., a user VM) performs I/O operations (e.g., a read operation or a write operation), the I/O commands may be sent to the hypervisor that shares the same server (e.g., computing node) as the user process, in examples utilizing hypervisors. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 156. Additionally or alternatively, CVMs 136, 138, 140 may present an emulated storage controller either to the hypervisor or to user VMs to facilitate I/O operations. CVMs 136, 138, 140 may be connected to storage within storage pool 156. CVM 136 may have the ability to perform I/O operations using CVM 136 within the same host machine 102, by connecting via network 154 to cloud storage 126 and/or network-attached storage 130, or by connecting via network 154 to controller VM 138 or 140 within another host machine 104 or 106 (e.g., via connecting to another CVM 138 or 140). In particular embodiments, any computing system may be used to implement a host machine. While 3 host machines are shown in FIG. 1, other numbers may be used in some examples.

Examples described herein include virtualized file servers. A virtualized file server may be implemented using a cluster of virtualized software instances (e.g., a cluster of file server virtual machines). A virtualized file server 134 is shown in FIG. 1 including a cluster of file server virtual machines. The file server virtual machines may additionally or instead be implemented using containers. In some examples, the VFS 134 provides file services to user VMs—e.g., user VM 114, 116, 118, 120, 122, and 124. The file services may include storing and retrieving data persistently, reliably, and/or efficiently in some examples. The user virtual machines may execute user processes, such as office applications or the like, on host machines 102, 104, and 106. The stored data may be represented as a set of storage items, such as files organized in a hierarchical structure of folders (also known as directories), which can contain files and other folders, and shares, which can also contain files and folders.

In particular embodiments, the VFS 134 may include a set of File Server Virtual Machines (FSVMs) 108, 110, and 112 that execute on host machines 102, 104, and 106. The set of file server virtual machines (FSVMs) may operate together to form a cluster. The FSVMs may process storage item access operations requested by user VMs executing on the host machines 102, 104, and 106. The FSVMs 108, 110, and 112 may communicate with storage controllers provided by CVMs 136, 138, 140 and/or hypervisors executing on the host machines 102, 104, and 106 to store and retrieve files, folders, SMB shares, or other storage items. The FSVMs 108, 110, and 112 may store and retrieve block-level data on the host machines 102, 104, and 106, e.g., on the local storage 148, 150, 152 of the host machines 102, 104, 106. The block-level data may include block-level representations of the storage items. The network protocol used for communication between user VMs, FSVMs, CVMs, and/or hypervisors via the network 154 may be Internet Small Computer Systems Interface (iSCSI), Server Message Block (SMB), Network File System (NFS), pNFS (Parallel NFS), or another appropriate protocol.

Generally, FSVMs may be utilized to receive and process requests in accordance with a file system protocol—e.g., NFS and/or SMB. In this manner, the cluster of FSVMs may provide a file system that may present files, folders, and/or a directory structure to users, where the files, folders, and/or directory structure may be distributed across a storage pool in one or more shares. The FSVMs may respond to NFS and/or SMB requests and may present one or more file system shares for access by users.

For the purposes of VFS 134, host machine 106 may be designated as a leader node within a cluster of host machines. In this case, FSVM 112 on host machine 106 may be designated to perform such operations. A leader may be responsible for monitoring or handling requests from FSVMs on other host machines throughout the virtualized environment. If FSVM 112 fails, a new leader may be designated for VFS 134.

In some examples, the user VMs may send data to the VFS 134 using write requests, and may receive data from it using read requests. The read and write requests, and their associated parameters, data, and results, may be sent between a user VM and one or more file server VMs (FSVMs) located on the same host machine as the user VM or on different host machines from the user VM. The read and write requests may be sent between host machines 102, 104, 106 via network 154, e.g., using a network communication protocol such as iSCSI, CIFS, SMB, TCP, IP, or the like. When a read or write request is sent between two VMs located on the same one of the host machines 102, 104, 106 (e.g., between the user VM 114 and the file server VM 108 located on the host machine 102), the request may be sent using local communication within the host machine 102 instead of via the network 154. Such local communication may be faster than communication via the network 154 in some examples. The local communication may be performed by, e.g., writing to and reading from shared memory accessible by the user VM 114 and the file server VM 108, sending and receiving data via a local “loopback” network interface, local stream communication, or the like.

In some examples, the storage items stored by the VFS 134, such as files and folders, may be distributed amongst storage managed by multiple FSVMs 108, 110, 112. In some examples, when storage access requests are received from the user VMs, the VFS 134 identifies FSVMs 108, 110, 112 at which requested storage items, e.g., folders, files, or portions thereof, are stored or managed, and directs the user VMs to the locations of the storage items. The FSVMs 108, 110, 112 may maintain a storage map, such as a sharding map, that maps names or identifiers of storage items to their corresponding locations. The storage map may be a distributed data structure of which copies are maintained at each FSVM 108, 110, 112 and accessed using distributed locks or other storage item access operations. In some examples, the storage map may be maintained by an FSVM at a leader node such as the FSVM 112, and the other FSVMs 108 and 110 may send requests to query and update the storage map to the leader FSVM 112. Other implementations of the storage map are possible using appropriate techniques to provide asynchronous data access to a shared resource by multiple readers and writers. The storage map may map names or identifiers of storage items in the form of text strings or numeric identifiers, such as folder names, files names, and/or identifiers of portions of folders or files (e.g., numeric start offset positions and counts in bytes or other units) to locations of the files, folders, or portions thereof. Locations may be represented as names of FSVMs, e.g., “FSVM-1”, as network addresses of host machines on which FSVMs are located (e.g., “ip-addr1” or 128.1.1.10), or as other types of location identifiers.

When a user application, e.g., executing in a user VM 114 on host machine 102 initiates a storage access operation, such as reading or writing data, the user VM 114 may send the storage access operation in a request to one of the FSVMs 108, 110, 112 on one of the host machines 102, 104, 106. A FSVM 108 executing on a host machine 102 that receives a storage access request may use the storage map to determine whether the requested file or folder is located on and/or managed by the FSVM 108. If the requested file or folder is located on and/or managed by the FSVM 108, the FSVM 108 executes the requested storage access operation. Otherwise, the FSVM 108 responds to the request with an indication that the data is not on the FSVM 108, and may redirect the requesting user VM 114 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 108 by sending a file service operation that creates the file or folder to a CVM, container, and/or hypervisor associated with (e.g., located on the same host machine as) the FSVM 108—the CVM 136 in the example of FIG. 1. The CVM, container, and/or hypervisor may subsequently processes file service commands for that file for the FSVM 108 and send corresponding storage access operations to storage devices associated with the file. In some examples, the FSVM may perform these functions itself. The CVM 136 may associate local storage 148 with the file if there is sufficient free space on local storage 148. Alternatively, the CVM 136 may associate a storage device located on another computing node 104, e.g., in local storage 150, with the file under certain conditions, e.g., if there is insufficient free space on the local storage 148, or if storage access operations between the CVM 136 and the file are expected to be infrequent. Files and folders, or portions thereof, may also be stored on other storage devices, such as the network-attached storage 130 or the cloud storage 126 of the storage pool 156.

In some examples, a name service 128, such as that specified by the Domain Name System (DNS) Internet protocol, may communicate with the host machines 102, 104, 106 via the network 154 and may store a database of domain names (e.g., host names) to IP address mappings. The domain names may correspond to FSVMs, e.g., fsvm1.domain.com or ip-addr1.domain.com for an FSVM named FSVM-1. The name service 128 may be queried by the user VMs to determine the IP address of a particular host machine 102, 104, 106 given a name of the host machine, e.g., to determine the IP address of the host name ip-addr1 for the host machine 102. The name service 128 may be located on a separate server computer system or on one or more of the host machines 102, 104, 106. The names and IP addresses of the host machines of the VFS 134, e.g., the host machines 102, 104, 106, may be stored in the name service 128 so that the user VMs may determine the IP address of each of the host machines 102, 104, 106, or FSVMs 108, 110, 112. The name of each VFS instance, e.g., FS1, FS2, or the like, may be stored in the name service 128 in association with a set of one or more names that contains the name(s) of the host machines 102, 104, 106 or FSVMs 108, 110, 112 of the VFS 134. The FSVMs 108, 110, 112 may be associated with the host names ip-addr1, ip-addr2, and ip-addr3, respectively. For example, the file server instance name FS1.domain.com may be associated with the host names ip-addr1, ip-addr2, and ip-addr3 in the name service 128, so that a query of the name service 128 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 128 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 128 for the address of the VFS instance for storage items for which the user VMs do not have a record or cache entry, as described below.

In some examples, each FSVM may have two IP addresses: an external IP address and an internal IP address. The external IP addresses may be used by SMB/CIFS clients, such as user VMs, to connect to the FSVMs. The external IP addresses may be stored in the name service 128. The IP addresses ip-addr1, ip-addr2, and ip-addr3 described above are examples of external IP addresses. The internal IP addresses may be used for iSCSI communication to CVMs, e.g., between the FSVMs 108, 110, 112 and the CVMs 136, 138, 140. Other internal communications may be sent via the internal IP addresses as well, e.g., file server configuration information may be sent from the CVMs to the FSVMs using the internal IP addresses, and the CVMs may get file server statistics from the FSVMs via internal communication.

Since the VFS 134 is provided by a distributed cluster of FSVMs 108, 110, 112, the user VMs that access particular requested storage items, such as files or folders, do not necessarily know the locations of the requested storage items when the request is received. A distributed file system protocol, e.g., MICROSOFT DFS or the like, may therefore be used, in which a user VM 114 may request the addresses of FSVMs 108, 110, 112 from a name service 128 (e.g., DNS). The name service 128 may send one or more network addresses of FSVMs 108, 110, 112 to the user VM 114. The addresses may be sent in an order that changes for each subsequent request in some examples. These network addresses are not necessarily the addresses of the file server VM 108 on which the storage item requested by the user VM 114 is located, since the name service 128 does not necessarily have information about the mapping between storage items and FSVMs 108, 110, 112. Next, the user VM 114 may send an access request to one of the network addresses provided by the name service, e.g., the address of FSVM 108. The FSVM 108 may receive the access request and determine whether the storage item identified by the request is located on the FSVM 108. If so, the FSVM 108 may process the request and send the results to the requesting user VM 114. However, if the identified storage item is located on a different FSVM 110, then the FSVM 108 may redirect the user VM 114 to the FSVM 110 on which the requested storage item is located by sending a “redirect” response referencing FSVM 108 to the user VM 114. The user VM 114 may then send the access request to FSVM 110, which may perform the requested operation for the identified storage item.

While a variety of functionality is described herein with reference to an example architecture shown in FIG. 1, it is to be understood that the functionality may be flexible with regard to which software process is used to perform the functionality. For example, functions described with respect to controller VMs may in some examples be performed by one or more hypervisors. Functions described with respect to FSVMs may in some examples additionally or instead be performed by one or more management processes operating on the computing node.

A particular VFS 134, including the items it stores, e.g., files and folders, may be referred to herein as a VFS “instance” and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients, such as user VMs, by name, e.g., “\Folder-1\File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1\File-1”, in storage access operations. If the storage items are stored on a share (e.g., a shared drive), then the share name may be used to access the storage items, e.g., via the path name “\\Share-1\Folder-1\File-1” to access File-1 in folder Folder-1 on a share named Share-1.

In particular embodiments, although the VFS may store different folders, files, or portions thereof at different locations, e.g., on different FSVMs, the use of different FSVMs or other elements of storage pool 156 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, may similarly be location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 134 determines the location, e.g., FSVM, at which to store a storage item when the storage item is created. For example, a FSVM 108 may attempt to create a file or folder using a CVM 136 on the same host machine 102 as the user VM 114 that requested creation of the file, so that the CVM 136 that controls access operations to the file folder is co-located with the user VM 114. While operations with a CVM are described herein, the operations could also or instead occur using a hypervisor and/or container in some examples. In this way, since the user VM 114 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 134 may also attempt to store the file on a storage device that is local to the CVM being used to create the file, such as local storage, so that storage access operations between the CVM and local storage may use local or short-distance communication.

In some examples, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In some examples, if a virtual machine, such as a user VM 114, CVM 136, or FSVM 108, moves from a host machine 102 to a destination host machine 104, e.g., because of resource availability changes, and data items such as files or folders associated with the VM are not locally accessible on the destination host machine 104, then data migration may be performed for the data items associated with the moved VM to migrate them to the new host machine 104, so that they are local to the moved VM on the new host machine 104. FSVMs may detect removal and addition of CVMs (as may occur, for example, when a CVM fails or is shut down) via the iSCSI protocol or other technique, such as heartbeat messages. As another example, a FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 134 may change the location of the file by, for example, copying the file from its existing location(s), such as local storage 148 of a host machine 102, to its new location(s), such as local storage 150 of host machine 104 (and to or from other host machines, such as local storage 152 of host machine 106 if appropriate), and deleting the file from its existing location(s). Write operations on the file may be blocked or queued while the file is being copied, so that the copy is consistent. The VFS 134 may also redirect storage access requests for the file from an FSVM at the file's existing location to a FSVM at the file's new location.

In particular embodiments, VFS 134 includes at least three File Server Virtual Machines (FSVMs) 108, 110, 112 located on three respective host machines 102, 104, 106. To provide high-availability, in some examples, there may be a maximum of one FSVM for a particular VFS instance VFS 134 per host machine in a cluster. If two FSVMs are detected on a single host machine, then one of the FSVMs may be moved to another host machine automatically in some examples, or the user (e.g., system administrator) may be notified to move the FSVM to another host machine. The user may move a FSVM to another host machine using an administrative interface that provides commands for starting, stopping, and moving FSVMs between host machines.

In some examples, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine would result in loss of two-thirds of the FSVMs for the VFS instance, which may be more disruptive and more difficult to recover from than loss of one-third of the FSVMs for the VFS instance.

In some examples, users, such as system administrators or other users of the system and/or user VMs, may expand the cluster of FSVMs by adding additional FSVMs. Each FSVM may be associated with at least one network address, such as an IP (Internet Protocol) address of the host machine on which the FSVM resides. There may be multiple clusters, and all FSVMs of a particular VFS instance are ordinarily in the same cluster. The VFS instance may be a member of a MICROSOFT ACTIVE DIRECTORY domain, which may provide authentication and other services such as name service.

In some examples, files hosted by a virtualized file server, such as the VFS 134, may be provided in shares—e.g., SMB shares and/or NFS exports. SMB shares may be distributed shares (e.g., home shares) and/or standard shares (e.g., general shares). NFS exports may be distributed exports (e.g., sharded exports) and/or standard exports (e.g., non-sharded exports). A standard share may in some examples be an SMB share and/or an NFS export hosted by a single FSVM (e.g., FSVM 108, FSVM 110, and/or FSVM 112 of FIG. 1). The standard share may be stored, e.g., in the storage pool in one or more volume groups and/or vDisks and may be hosted (e.g., accessed and/or managed) by the single FSVM. The standard share may correspond to a particular folder (e.g., \\enterprise\finance may be hosted on one FSVM, \\enterprise\hr on another FSVM). In some examples, distributed shares may be used which may distribute hosting of a top-level directory (e.g., a folder) across multiple FSVMs. So, for example, \\enterprise\users\ann and \\enterprise\users\bob may be hosted at a first FSVM, while \\enterprise\users\chris and \\enterprise\users\dan are hosted at a second FSVM. In this manner a top-level directory (e.g., \\enterprise\users) may be hosted across multiple FSVMs. This may also be referred to as a sharded or distributed share (e.g., a sharded SMB share). As discussed, a distributed file system protocol, e.g., MICROSOFT DFS or the like, may be used, in which a user VM may request the addresses of FSVMs 108, 110, 112 from a name service (e.g., DNS).

Accordingly, systems described herein may include one or more virtual file servers, where each virtual file server may include a cluster of file server VMs and/or containers operating together to provide a file system.

Examples described herein may provide a distributed database. A distributed database may generally refer to a collection of data stored across multiple storage locations. The distributed database may have multiple database management systems (e.g., database service instances) which may access, create, maintain, and/or revise data in the distributed database. The database management systems may be located on multiple host systems (e.g., computing nodes). The multiple database management systems may work together to present a database to a client user—allowing for flexibility regarding the specific hardware used to service database requests and store database data. Individual database management systems may each maintain a cache of some or all of the distributed database data. In examples described herein, the database management systems may utilize asynchronous callback techniques to update cached copies of database data at each database management system.

In the example of FIG. 1, a distributed database may include database service instance 158, database service instance 160, and database service instance 162. The database service instance 158, database service instance 160, and database service instance 162 may function together to provide a service to users (e.g., user VMs 114-124). The database service instance 158 may be hosted on computing node 102. The database service instance 160 may be hosted on computing node 104. The database service instance 162 may be hosted on computing node 106. Data hosted (e.g., maintained) by the distributed database may be distributed throughout the storage pool 156 in some examples—e.g., in local storage 148, local storage 150, local storage 152, cloud storage 126, and/or network-attached storage 130.

In the example of FIG. 1, the database service instances may be provided by file server VMs. The database service instance 158 may be provided by file server VM 108. The database service instance 160 may be provided by file server VM 110. The database service instance 162 may be provided by file server VM 112. In other examples, database service instances may be provided by other VMs, containers, and/or on their own.

Database service instances may each cache all and/or portions of database data. Generally, retrieval of the data from a cache may be faster and/or occur with less latency than retrieval of the data from the storage pool 156. In the example of FIG. 1, the database service instance 158 may maintain cache 168. The cache 168 may be implemented in a local memory of the computing node 102. The database service instance 160 may maintain cache 166. The cache 166 may be implemented in local memory of the computing node 104. The database service instance 162 may maintain cache 164. The cache 164 may be implemented in the local memory of computing node 106.

Any of a variety of policies may be utilized to determine what and/or how much data to store in caches of database service instances. For example, frequently-accessed data may be cached (e.g., data accessed within a threshold previous amount of time and/or accessed more than a threshold number of times in a time period). In some examples, particular kinds and/or types of data may be cached (e.g., high priority data and/or critical data). In some examples, a particular percentage of data may be cached relative to a size of the entire database. While each of the database service instances may implement different caching policies, in some examples the caching policies implemented by the database services instances may be similar and/or the same. Incoming database requests may be serviced by any of the database service instances—e.g., depending on load and/or computing node originating the request. Accordingly, the desirability of cached data may not be expected to vary across the computing nodes hosting the distributed database management systems. Rather, the selection of cached data may be made from the perspective of the distributed database as a whole, and generally the same cached data maintained at each database service instance. For example, the caching policy may refer to an access frequency, not by a particular database service instance, but by the collection of database service instances. So, for example, data may be cached at each of cache 164, cache 166, and cache 168 when it had been access by any of the database service instances within a particular time, and/or had been accessed a total of over a threshold number of times by any of the database service instances a particular time period.

Distributed databases may be used to host generally any data. While examples are provided herein in the context of distributed file servers, distributed databases described herein may be utilized in other contexts in other examples. In the context of the distributed file server, VFS 134, of FIG. 1, the distributed database may, for example, provide metadata regarding the VFS 134. The distributed database may provide a storage or sharding map for the VFS 134. For example, the distributed database may provide metadata regarding the file and folder structure of the VFS 134.

The distributed database may accordingly be utilized to facilitate the access of files hosted by the VFS 134. For example, consider an incoming file server request provided to a particular FSVM—e.g., the user VM 114 providing a request for a particular filename and/or file path to the FSVM on its node (e.g., file server VM 108). The file server VM 108 may query the database service instance 158 to determine a location of a particular subfolder and/or folder in the file path or which includes the particular filename. The distributed database may identify a computing node which hosts the particular subfolder and/or folder or the particular filename. The file server VM 108 may accordingly redirect the request for the particular filename and/or file path to the appropriate computing node and/or FSVM (e.g., as indicated by the metadata in the distributed database).

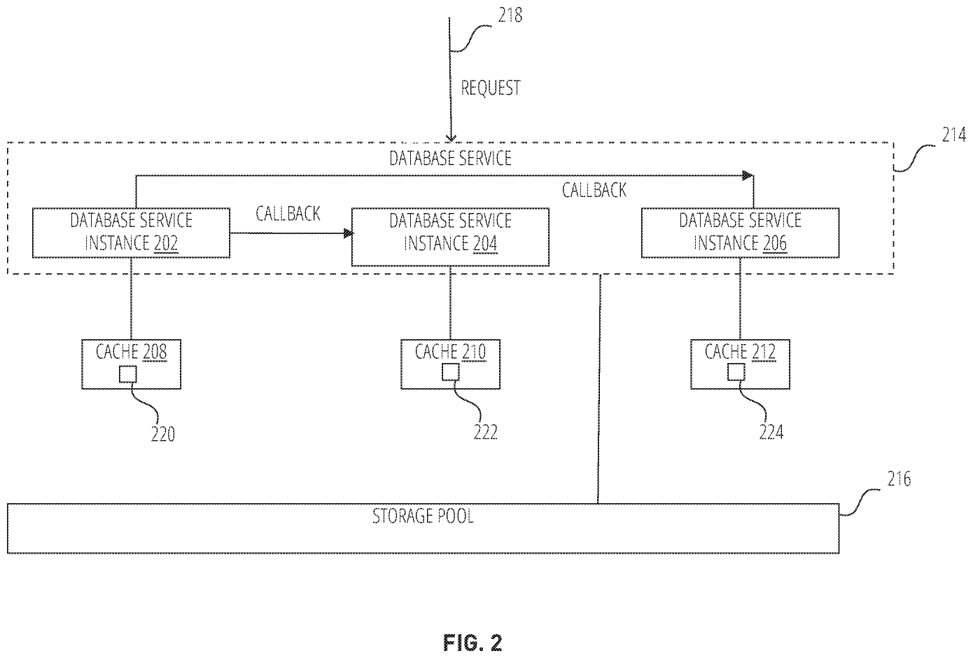

FIG. 2 is a schematic illustration of a distributed database arranged in accordance with examples described herein. The distributed database of FIG. 2 may implement asynchronous callback techniques to maintain data in one or more caches of the distributed database. The distributed database of FIG. 2 includes database service 214 which includes database service instance 202, database service instance 204, and database service instance 206. The database service instance 202 is coupled to cache 208. The database service instance 204 is coupled to cache 210. The database service instance 206 is coupled to cache 212. The distributed database may include a storage pool 216. The database service instance 202, database service instance 204, and database service instance 206 may access the storage pool 216. The cache 208, cache 210, and cache 212 may cache data from the storage pool 216. The distributed database may receive request 218. The cache 208 includes updated data 220. The cache 210 includes updated data 222. The cache 212 includes updated data 224. The components shown in FIG. 2 are examples. Additional, fewer, and/or different components may be used in other examples.

The system of FIG. 1 may be used to implement the distributed database of FIG. 2 in some examples. For example, the database service instance 158, database service instance 160, and database service instance 162 of FIG. 1 may be used to implement and/or may be implemented by database service instance 202, database service instance 204, and database service instance 206 of FIG. 2. The cache 168, cache 166, and cache 164 of FIG. 1 may be used to implement and/or may be implemented by cache 208, cache 210, and cache 212 of FIG. 2. The storage pool 156 of FIG. 1 may be used to implement and/or may be implemented by storage pool 216 of FIG. 2.

During operation, the database service 214 may receive a request 218 which may be serviced by one or more of database service instance 202, database service instance 204, and/or database service instance 206. The request may result in updated data 220 being created, updated, and/or changed in cache 208. Responsive to changes of the data in cache 208, the database service instance 202 may send callbacks to one or more other database service instances (e.g., database service instance 204, database service instance 206) and/or caches (e.g., cache 208, cache 210, and cache 212). The callbacks may cause database service instance 204 to provide updated data 222, and database service instance 206 to provide updated data 224.

Examples described herein accordingly may provide a distributed database. The distributed database may have a database service, such as database service 214. The database service may also be referred to as a database management system. The database service may receive and respond to request to access and/or modify data in the distributed database. The database service may generally maintain the data in the distributed database. The database service may be implemented using one or more computing devices—e.g., one or more processor(s) and computer readable media encoded with instructions which, when executed, cause the processor(s) and/or database service to perform the actions described herein.

Database services described herein may be distributed. For example, the processing functionality used to implement a database service may be divided between one or more database service instances. In the example of FIG. 2, the database service 214 is distributed and includes database service instance 202, database service instance 204, database service instance 206. Although three database service instances are shown in FIG. 2, generally any number may be present in other examples. The database service instances work together to perform the functions of the database service. For example, the database service instances may be in a cluster. Each database service instance may be hosted by a different computing device (e.g., computing node) in some examples. For example, the database service instance 202 may be hosted by host machine 102 of FIG. 1, database service instance 204 may be hosted by host machine 104 of FIG. 1, and database service instance 206 may be hosted by host machine 106 of FIG. 1. In some examples, multiple database service instances may be hosted by a same host machine. Database service instances may be executed in one or more virtual machines in some examples. Database service instances may be provided in one or more containers in some examples. The host machines hosting the database service instances may form a cluster. One or more database service instances may serve as a leader. The leader may coordinate action amongst the database service instances in some examples. For example, the leader may receive requests for access to the database (e.g., request 218) and may provide the request to a selected database service instance for acting on the request. The database service instance used to act on the request may be selected in accordance with request type, workload on the database service instances, host machine parameters for the database service instances, etc. Other criteria may be used.

Database services described herein may include data stored in a storage pool, such as storage pool 216 of FIG. 2. Accordingly, the data hosted by database services described herein may be distributed. For example, the storage pool 216 may include various storage devices which may be hosted by various computing devices. In some examples, the storage pool 216 may be implemented by the storage pool 156 of FIG. 1. The storage pool 216 may include storage local to host devices used to implement database service instances. In this manner, various access modalities may be used to access data in storage pool 216. For example, to access data in the storage pool 216, one or more networks may be used and/or one or more storage device interfaces. In some examples, there may be some amount of delay or latency involved in accessing the data in the storage pool 216.

Database service instances described herein may store all or a portion of the database data in a cache. For example, the database service instance 202 may maintain cache 208. The database service instance 204 may maintain cache 210. The database service instance 206 may maintain cache 212. In some examples, the caches may additionally or instead be maintained by a cache management process. For example, the caches may be implemented using one or more cache modules. The cache module may include memory and one or more processors (e.g., controller, circuitry). The cache may accordingly itself host a cache management process. The cache may be located, for example, in a memory (e.g., local memory) of a computing device used to host the database service instance. The data stored in the caches may also be stored in the storage pool, but the local copy may advantageously provide for faster access times and/or lower latency for the data that is stored in the cache. Caches may store data in any of a variety of data structures, such as a map. Caches may be synchronized using relevant primitives in some examples (e.g., one or more mutual exclusion primitives, mutex). The caches may be implemented using least recently used (LRU) caches in some examples. An LRU cache may be a cache having a least used item evicted to make space for a new item.

Any of a variety of policies may be utilized to determine which, and how much, data to cache. For example, a lead database service instance may determine which data and/or how much data should be cached. Examples of policies include caching a particular percentage of data in the distributed database, caching data accessed within a particular previous period of time, and/or caching data accessed more than a threshold number of times within a previous period of time. Generally, each database service instance may implement a same cache policy of the database service. Accordingly, the cached data may generally be the same for each database service instance. For example, data in cache 208, cache 210, and cache 212 of FIG. 2 may generally be the same, as it may be selected in accordance with a same caching policy. Additionally, the cache policy may utilize information from the entire database service, not only individual database service instances. For example, if data is cached based on data accessed within a particular previous period of time, it may be cached by each of the database service instances based on an access by any of the database service instances. If data is cached based on data accessed a threshold number of times within a time period, it may be cached based on a total number of access by all of the database service instances in that period.

During operation, a request (e.g., request 218 of FIG. 2) may be received by a database service, e.g., database service 214. The request may come from a user (e.g., an individual and/or another process or service). For example, the request may originate from an application, a service, a user VM, another virtual machine, etc. The request may be a request to access data, read data, write data, create data, or another requested manipulation to a distributed database. The request may be provided to a database service instance. For example, the request may be received by a lead database service instance (e.g., database service instance 204) and may be provided to a selected database service instance to respond to the request (e.g., database service instance 202). If the data for response to the request is present in a cache, the database service may access the data from the cache. For example, the request 218 may be a request to read a particular data value. The request may be provided to database service instance 202. The database service instance 202 may determine (e.g., using a look-up table, map, or query) whether the requested data is in cache 208. If the data is in the cache 208, the data may be read from the cache 208 and returned (e.g., output from the database service instance 202) to the requestor. If the data is not in the cache, the data may be read from storage pool 216 by the database service instance 202 and returned to the requestor. Reading the data from storage pool 216 may take longer than reading from the cache 208—for example, data may be located on a remote node and may need to be accessed on the remote node. Accordingly, in some examples, distributed database services described herein may utilize a cache for read operations.

In some examples of distributed database services, write operations may be handled without reference to a cache. In some examples, a write request may be received by a database service instance, and may be processed by accessing and modifying the data in the storage pool, not the cache. The caches may later then be updated through a callback mechanism. In some examples, because the caches are updated via callbacks that may not be inline with the actual write in the database, a read from another node where the cache update has not been received (e.g., is delayed) can be inconsistent for a small duration of time. However, many applications are tolerant to this delay and an eventual consistency model may be used. It may generally be advantageous to update all caches as expeditiously as possible. In some examples, however, the cache may be involved in a write request. For example, the database service instance 202 may receive a write request for data. If the data is determined to be in cache 208, the write may be implemented on the cache 208, resulting in updated data 220. The write may also be implemented using the database service 214, e.g., the database service instance 202 may update the data in the storage pool 216. Accordingly, a request may result in a change to data stored in the database and/or cache. For example, the request may request data be changed (e.g., created and/or written). Additionally or instead, the request may result in certain requested data being qualified to be cached (e.g., stored in cache 208, cache 210, and cache 212 as well as storage pool 216). In some examples, the database service instance 202 may respond to the request 218 by making a change in the data in cache 208, such as by creating updated data 220. The updated data 220 may be data that was updated (e.g., created, written, changed, cached). It may be desirable for the remaining database service instances to update their caches in an analogous manner. Note that in some examples, when a write is performed by a node, the local node's cache may be updated without waiting to receive a callback performed by operation of the database service. For example, if the database service instance 202 receives a write request, it may process the write request to identify the location of the data in the storage pool 216 to update, but it may additionally (e.g., immediately) update cache 208 with updated data 220. Accordingly, database service instance 202 need not receive a callback in some examples in order to update cache 208.

Examples described herein accordingly may use watch based mechanisms to maintain synchronization between one or more caches and the storage pool. For example, described herein, responsive to a change in data in a cache, a database service instance may send a callback to one or more (e.g., all) other database service instances of the database service. A callback generally refers to code provided for execution by another process (e.g., a database service instance). The callback may cause the receiving database service instances to update their caches. In some examples, asynchronous callbacks may be used. Asynchronous callbacks generally refer to callbacks which may cause a background process to run (e.g., it may not block other operations). The callback may contain any of a variety of information. In some examples, the callback may include an indication of data to be updated. In some examples, the callback may additionally or instead include the data to be updated. The callback may be attached to updates for the database. For example, the callback may be attached to a request to update data in the storage pool 216 in some examples. In the example of FIG. 2, the database service instance 202 may provide a callback to the database service instance 204 and database service instance 206. Responsive to receipt of a callback, a database service instance may update its cache. In some examples, the cache may be updated using data received in the callback. In some examples, the receiving database service instance may request the data indicated in the callback from another database service instance's cache and/or the storage pool. In the example of FIG. 2, the database service instance 204 may, responsive to receipt of a callback from database service instance 202, update the cache 210 to include updated data 222. The updated data 222 may correspond with the updated data 220. The database service instance 206 may, responsive to receipt of a callback from database service instance 202, update the cache 212 to include updated data 224. The updated data 224 may correspond with updated data 220. In the example of FIG. 2, the database service instance 202 is shown providing callbacks to database service instance 204 and database service instance 206. At other times, it is to be understood that the database service instance 204 may provide callbacks to database service instance 202 and/or database service instance 206 responsive to updates to cache 210. The database service instance 206 may provide callbacks to database service instance 202 and/or database service instance 204 responsive to updates to cache 212.

Database service instances described herein may update the storage pool with updated data from their cache. For example, the database service instance 202 may, responsive to creating and/or updating cache 208, update storage pool 216 to include updated data 220. The update of the storage pool may occur in parallel with the callbacks and updates of the caches in the distributed system. Accordingly, in some examples, cache 212 and cache 210 may be updated responsive to the callbacks shown in FIG. 2 prior to the storage pool 216 being updated with the updated data 220.

During operation, one or more of the caches—e.g., cache 208, cache 210, and/or cache 212 may become disconnected from one or more database service instances and/or the network and/or a network partition of other computing nodes which may host other database service instances. Disconnection may occur, for example, if a computing node and/or fails, is destroyed, stolen, goes down, loses power, is shut down, and/or malfunctions. Disconnection may occur if the database service instance and/or cache malfunctions, goes down, is terminated, or otherwise stops functioning. Disconnection may occur, for example if a connection (e.g., a TCP connection) is disrupted or broken between the cache and one or more database service instances. In some examples, the disconnect may occur prior to invocation and/or receipt of a callback. Accordingly, responsive to a disconnection from a database service instance and/or network, the disconnected cache may be marked as invalid. For example, the cache may be marked as invalid by a cache management process (e.g., the cache may mark certain data and/or the entire cache as invalid), and/or a database service instance. The invalid mark may for example, be a flag, bit, or other marker written to the cache to indicate potentially invalid data is contained in the cache. When the cache is marked as invalid, the database service instance may not respond to requests using data from the cache, rather the requested data will be accessed from the distributed database (e.g., the storage pool). The database service instance and/or cache management process may initialize (e.g., refresh) a cache when marked as invalid. For example, if the cache 208 is marked as invalid, when the database service instance 202 re-establishes communication with the cache 208 and/or with other database service instances in the database service, the database service instance 202 may initialize the cache 208. The cache 208 may be initialized, for example, by obtaining data from the storage pool 216 corresponding to the data in the cache 208 to confirm that the data in the cache 208 is current. The database service instance 202 may sign up for new asynchronous callbacks for updates from that point onwards after the cache has been initialized.

Examples of distributed database systems described herein may achieve performance advantages in some examples. Lookups resulting in cache hits for reads, for example, may be significantly sped up by caching some or all of the data locally. In some examples, a distributed database may be utilized to store login data. In an example implementing a virtual desktop infrastructure (VDI), login times may be decreased—in one example decreased from 10+ minutes to just under 20 seconds. When a large number of connected clients are expected, distributed database access time may dominate the access time, so savings to database access times may be significant to performance of the system.

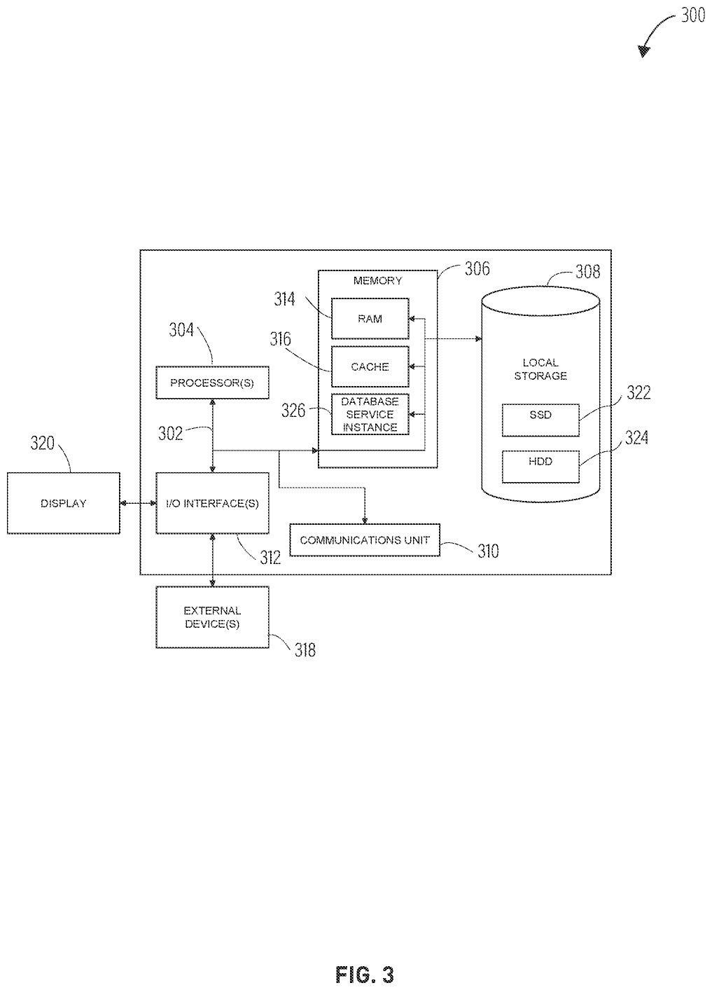

FIG. 3 depicts a block diagram of components of a computing node 300 in accordance with examples described herein. It should be appreciated that FIG. 3 provides only an illustration of one implementation and does not imply any limitations with regard to the environments in which different embodiments may be implemented. Many modifications to the depicted environment may be made. The computing node 300 may be used to implement and/or may be implemented by the computing node 102, computing node 104, and/or computing node 106 of FIG. 1, for example. The components shown in FIG. 3 are exemplary only, and it is to be understood that additional, fewer, and/or different components may be used in other examples.

The computing node 300 includes one or more communications fabric(s) 302, which provide communications between one or more processor(s) 304, memory 306, local storage 308, communications unit 310, and/or I/O interface(s) 312. The communications fabric(s) 302 can be implemented with any architecture designed for passing data and/or control information between processors (such as microprocessors, communications and network processors, etc.), system memory, peripheral devices, and any other hardware components within a system. For example, the communications fabric(s) 302 can be implemented with one or more buses.

The memory 306 and the local storage 308 may be computer-readable storage media. In the example of FIG. 3, the memory 306 includes random access memory RAM 314 and cache 316. The cache 316 may be used, for example, to implement cache 208, cache 210, cache 212 of FIG. 2, and/or cache 164, cache 166, and/or cache 168 of FIG. 1. In general, the memory 306 can include any suitable volatile or non-volatile computer-readable storage media. The local storage 308 may be implemented as described above with respect to local storage 308 or other local storage of FIG. 1, for example. In this embodiment, the local storage 308 includes an SSD 322 and an HDD 324. The memory 306 may include executable instructions for providing a database service described herein, such as for providing database service instance 326. The instructions for providing database service instance 326 may be used to implement and/or implemented by database service instance 158, database service instance 160, database service instance 162 of FIG. 1 and/or database service instance 202, database service instance 204, and/or database service instance 206 of FIG. 2.

Various computer instructions, programs, files, images, etc. may be stored in local storage 308 and/or memory 306 for execution by one or more of the respective processor(s) 304 via one or more memories of memory 306. In some examples, local storage 308 includes a magnetic HDD 324. Alternatively, or in addition to a magnetic hard disk drive, local storage 308 can include the SSD 322, a semiconductor storage device, a read-only memory (ROM), an erasable programmable read-only memory (EPROM), a flash memory, or any other computer-readable storage media that is capable of storing program instructions or digital information.

The media used by local storage 308 may also be removable. For example, a removable hard drive may be used for local storage 308. Other examples include optical and magnetic disks, thumb drives, and smart cards that are inserted into a drive for transfer onto another computer-readable storage medium that is also part of local storage 308.

Communications unit 310, in some examples, provides for communications with other data processing systems or devices. For example, communications unit 310 may include one or more network interface cards. Communications unit 310 may provide communications through the use of either or both physical and wireless communications links.

I/O interface(s) 312 may allow for input and output of data with other devices that may be connected to computing node 300. For example, I/O interface(s) 312 may provide a connection to external device(s) 318 such as a keyboard, a keypad, a touch screen, and/or some other suitable input device. External device(s) 318 can also include portable computer-readable storage media such as, for example, thumb drives, portable optical or magnetic disks, and memory cards. Software and data used to practice embodiments of the present invention can be stored on such portable computer-readable storage media and can be loaded onto and/or encoded in memory 306 and/or local storage 308 via I/O interface(s) 312 in some examples. I/O interface(s) 312 may connect to a display 320. Display 320 may provide a mechanism to display data to a user and may be, for example, a computer monitor.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. A computer readable media encoded with instructions that, when executed, cause a computing node to:
provide an instance of a distributed database service, configured to operate together with other instances in a computing cluster to provide a distributed database;
update a local cache copy of certain data hosted by the distributed database service; and
responsive to the updating, provide a callback to another instance of the distributed database service in the computing cluster indicative of the update.

2. The computer readable media of claim 1, wherein the instructions further comprise instructions which, when executed, cause the computing node to:
receive another callback from at least one other computing node in the computing cluster, wherein the callback is indicative of updated data for the local cache copy.

3. The computer readable media of claim 2, wherein the instructions further comprise instructions which, when executed, cause the computing node to:
update the local cache copy with the updated data.

4. The computer readable media of claim 1, wherein the distributed database is configured to provide metadata for a file system hosted by the computing cluster.

5. The computer readable media of claim 1, wherein said update the local cache copy comprises accessing a local memory of the computing node.

6. The computer readable media of claim 1, wherein the distributed database service is configured to provide access to database data distributed across the computing cluster.

7. The computer readable media of claim 1, wherein the instructions, when executed, further cause the computing node to:
receive a request for particular data in the distributed database; and
return the particular data from the local cache copy when the particular data is present in the local cache copy.

8. A system comprising:
a plurality of computing nodes, each configured to:
host an instance of a distributed database service;
store cached data of the distributed database service in a local memory; and
provide a callback to other instances of the distributed database service responsive to updating the cached data;
a storage pool accessible to the plurality of computing nodes, the storage pool configured to store data of a distributed database across the plurality of computing nodes, wherein the cached data comprises a portion of the data of the distributed database.

9. The system of claim 8, wherein the plurality of computing nodes form a cluster which together hosts a plurality of instances of the distributed database service configured to function together to provide access to the data of the distributed database.

10. The system of claim 8, wherein the cached data is selected based on frequency of access across the plurality of computing nodes.

11. The system of claim 8, wherein the cached data at each of the plurality of computing nodes is the same.

12. The system of claim 8, wherein each of the plurality of computing nodes is further configured to receive another callback from another one of the plurality of computing nodes, the another callback indicative of updated data.

13. The system of claim 12, wherein each of the plurality of computing nodes is further configured to update the cached data responsive to the another callback.

14. The system of claim 13, wherein the callback and the another callback comprise asynchronous callbacks.

15. The system of claim 9, wherein the plurality of computing nodes are each further configured to receive a request for particular data of the distributed database, and provide the particular data from the cached data when available.

16. A method comprising:
cache certain data of a distributed database in a cache in local memory of each of a plurality of computing nodes;
service a request to update database data, by at least one of the plurality of computing nodes, by accessing the cache and modifying the cache;
provide a callback, by the at least one of the plurality of computing nodes, to at least another of the plurality of computing nodes, responsive the request to update the database data; and
update, by the at least another of the plurality of computing nodes, data in local memory of the another of the plurality of computing nodes responsive to the callback.

17. The method of claim 16, wherein the callback provides an indication of the data in the local memory to update.

18. The method of claim 16, wherein the callback provides updated database data.

19. The method of claim 16, wherein the certain data is selected based on an access frequency.

20. The method of claim 16, further comprising:
receiving, at the at least one of the plurality of computing nodes, another callback indicative of different updated data from another of the plurality of computing nodes.

21. The method of claim 20, further comprising:
updating, by the at least one of the plurality of computing nodes, the cache based on the callback indicative of the different updated data.
